(19) United States
(12) Patent Application Publication
(10) Pub. No.: US 2007/0148998 A1
(43) Pub. Date: Jun. 28, 2007

(54) Land grid array connector contact

(75) Inventors: Chi-Nan Liao, Tu-Cheng (TW); Li-Bang Chen, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/645,372

(22) Filed: Dec. 26, 2006

(30) Foreign Application Priority Data
Dec. 26, 2005 (TW) 94222627

(51) Int. Cl. H01R 12/00

(52) U.S. Cl. 439/66

(57) ABSTRACT

An LGA connector contact (1) according to an embodiment includes a vertical retention portion (10) for being secured in an LGA connector, and an upper engaging portion (11) connecting to the retention portion for engaging a mating contact of an IC package. The upper engaging portion includes a curved connection section (111) for connecting to an upper part of the vertical retention portion, and a resilient arm (113) extending from the curved connection section. The resilient arm is configured to extend angularly relative to the retention portion. As compared with the prior art, the connection section is configured to have a gradually decreased width relative to the upper part of the retention portion. This configuration of the connection section will minimize stress imposed on the contact connection section, thereby avoiding fatigue of the connector contact.

### BACKGROUND OF THE INVENTION

1. Field of the Invention

The present invention relates to the art of electrical connectors, and more particularly to a connector contact for used in an LGA connector.

2. Description of the Related Art

Various types of connectors have been developed for electrical connections to an IC package and a printed circuit board, such as Pin Grid Array (PGA) connectors, Ball Grid Array (BGA) connectors, Land Grid Array (LGA) connectors, etc., the names of which are assigned thereto based on conductive elements of the IC package that connectors electrically connect. Contacts resided within the respective connectors are accordingly classified as PGA contacts, BGA contacts, LGA contacts and so on.

A conventional LGA connector contact 1′ is shown in FIGS. 3 and 4. The LGA connector contact 1′ includes a vertical retention portion 10′ for holding the contact 1′ in position within an LGA connector (not shown), and an upper engaging portion 11′ attached to the vertical retention portion 10′ for engaging a mating contact of an IC package (not shown). The upper engaging portion 11′ includes a curved connection section 111′ with a uniform width (as particularly shown in FIG. 2), and a resilient arm 113′ configured to extend upwardly and obliquely from the curved connection section 111′. Typically, the curved connection section 111′ is directly bent from the vertical retention portion 10′.

A problem, however, with using the connector contact 1′ is that, the connector contact 1′ may be subjected to premature fatigue at the curved connection section 111′ after depressing the resilient arm 113′ for many times. This is so because stress is often concentrated on the uniform-width connection section 111′. This will result in damage of the connector contact 1′.

### SUMMARY OF THE INVENTION

An LGA connector contact according to an embodiment of the present invention is provided to include a vertical retention portion for being retained in a passageway of an LGA connector, an upper engaging portion and a lower engaging portion for connecting to the vertical retention portion. The lower engaging portion includes a lower contact section configured for being soldered to a printed circuit board. The upper engaging portion includes a curved connection section for being connected to an upper part of the vertical retention portion, and a resilient arm continuing the curved connection section for engaging a mating contact of an IC package. The resilient arm is configured to extend angularly relative to the retention portion. As compared with the prior art, the curved connection section is configured to have a gradually decreased width relative to the upper part of the retention portion. This configuration of the connection section will minimize stress connection imposed on the contact connection section, thereby avoiding fatigue of the connector contact.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is a perspective view of an LGA connector contact according to an ebodiment of the present invention;

FIG. 2 is an enlarged view of a circle part A of the LGA connector contact of FIG. 1;

FIG. 3 is a perspective view of a conventional LGA connector contact; and

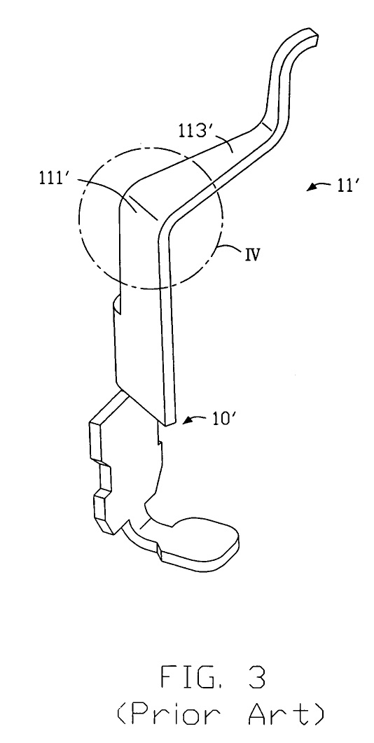

FIG. 4 is an enlarged view of a circle part B of the LGA connector contact of FIG. 3.

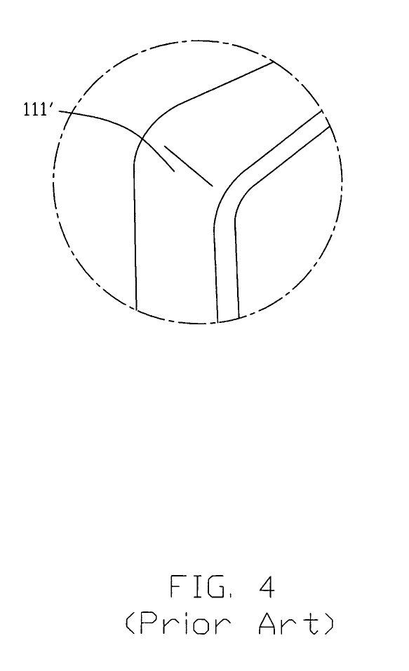

### DETAILED DESCRIPTION OF PREFERRED EMBODIMENT

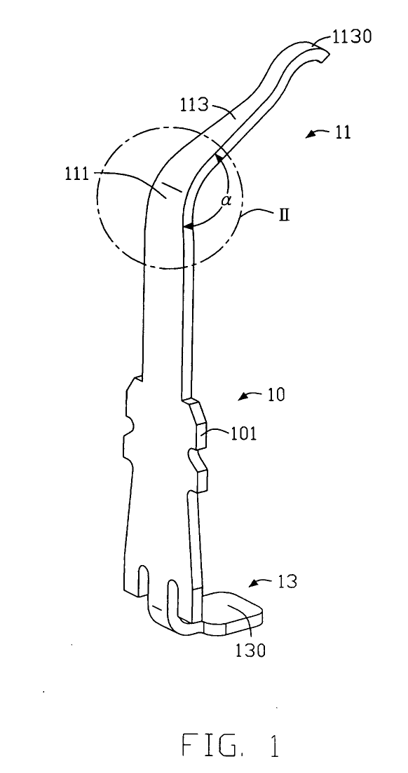

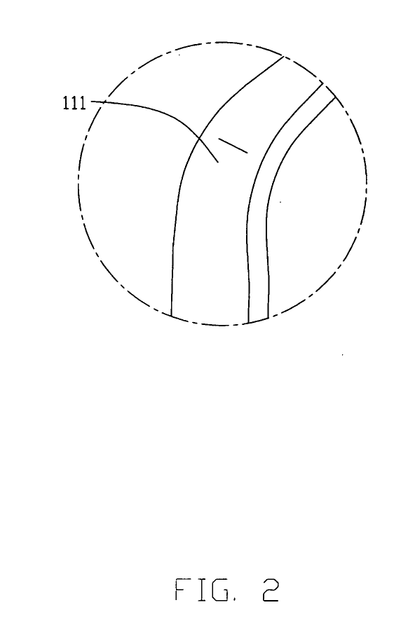

Referring to FIGS. 1 and 2, an LGA connector contact 1 according to the embodiment of the present invention is shown to include a vertical retention portion 10 for being retained in a passageway of an LGA connector, an upper engaging portion 11 and a lower engaging portion 13, respectively, connecting to an upper and a lower part of the retention portion 10 for engaging a corresponding mating contact of an electronic component as, for example, an IC package or a printed circuit board.

The retention portion 10 is substantially planar, and defines a vertical plane with side edges 101 dimensioned to create a frictional interference with side walls of the passageway of the LGA connector. The lower engaging portion 13 is formed by bending a tail of the connector contact 1, approximately at a right angle to the plane of the retention portion 10. The lower engaging portion 13 includes a lower contact section 130 configured for being soldered to a printed circuit board (not shown).

The upper engaging portion 11 further includes a curved connection section 111 for being connected to the upper part of the retention portion 10, and a resilient arm 113 extending from the curved connection section 111 and defining an upper curved contact section 1130 adapted for engaging a mating contact of an IC package (not shown). The resilient arm 113 is configured to extend angularly relative to the plane of the retention portion 10. In this embodiment, an obtuse angle “a” is formed between the resilient arm 113 and the plane of the retention portion 10. As compared with the prior art, the curved connection section 111 has a gradually decreased width relative to the upper part of the retention portion 10. This configuration of the connection section 111 will minimize stress connection imposed on the contact connection section 111, thereby avoiding fatigue of the connector contact 1.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. A land grid array (LGA) connector contact comprising:
a retention portion for being retained in a passageway of an LGA connector;
a lower engaging portion being connected to the retention portion, the lower engaging portion including a lower contact section configured to be soldered to a printed circuit board; and
an upper engaging portion including a curved connection section connected to an upper part of the retention portion, and a resilient arm continuing the curved connection section for engaging a mating contact of an IC package;
the resilient arm extending angularly relative to the retention portion;
said curved connection section having a gradually decreased width relative to the upper part of the retention portion.

2. The LGA connector contact as recited in claim 1, wherein the retention portion is substantially planar, and an obtuse angle is formed between the resilient arm and the plane of the retention portion.

3. The LGA connector contact as recited in claim 1, wherein the lower engaging portion is formed approximately at a right angle to the retention portion.

4. A land grid array (LGA) connector contact comprising:
a retention portion for being retained in a passageway of an LGA connector;
a lower engaging portion being connected to the retention portion for engaging a first electronic part; and
an upper engaging portion including a curved connection section connected to an upper part of the retention portion, and a resilient arm continuing the curved connection section for engaging a second electronic part;
the resilient arm extending angularly relative to the retention portion;
said curved connection section having a narrowed width relative to the upper part of the retention portion while having a large width relative to the resilient arm.

5. The LGA connector contact as claimed in claim 4, wherein said retention portion essentially extends in a vertical plane.

6. A land grid array (LGA) connector contact comprising:
a retention portion for being retained in a passageway of an LGA connector;
a lower engaging portion being connected to the retention portion for engaging a first electronic part; and
an upper engaging portion including a curved connection section connected to the retention portion, and a resilient arm continuing the curved connection section for engaging a second electronic part;
the resilient arm extending angularly relative to the retention portion;
said curved connection section having a narrowed width relative to the upper part of the retention portion while having a large width relative to the resilient arm; wherein
the retention portion extends essentially in a vertical plane.
